(19) United States
(12) Patent Application Publication
(10) Pub. No.: US 2025/0249775 A1
(43) Pub. Date: Aug. 7, 2025

(54) Thermal Management Module for an Electric Vehicle

(71) Applicant: MAHLE International GmbH, Stuttgart (DE)

(72) Inventors: Gunther HENTSCHEL, Stuttgart (DE); Thomas STRAUSS (Strauß), Stuttgart (DE)

(21) Appl. No.: 19/040,503

(22) Filed: Jan. 29, 2025

(30) Foreign Application Priority Data
Feb. 2, 2024 (DE) 102024103056.9

(51) Int. Cl. B60L 53/62; B60L 58/26; H01M 10/613; H01M 10/625; H01M 10/63; H01M 10/6567

(52) U.S. Cl. CPC B60L 53/62; B60L 58/26; H01M 10/613; H01M 10/625; H01M 10/63; H01M 10/6567; H01M 2220/20

(57) ABSTRACT

A thermal management module for an electric vehicle is provided. The thermal management module can be placed in a cooling circuit in an electric vehicle, and wherein the thermal management module is designed to regulate or control the flow of a coolant in the cooling circuit. The thermal management module contains at least one regulator, wherein the at least one regulator is designed to regulate or control the flow of the coolant through at least one heat sink.

### CROSS REFERENCE TO RELATED APPLICATIONS

This application claims priority from German Patent Application No. 10 2024 103 056.9, filed on Feb. 2, 2024, the entirety of which is hereby incorporated by reference herein.

The present invention relates to a thermal management module for an electric vehicle, a cooling circuit and a method for cooling a battery in an electric vehicle according to the independent claims.

DE 102018218474 A1 discloses a heating medium or coolant circuit for an electric vehicle in which there is a primary circuit for controlling the temperature of an electric motor and a battery in the electric vehicle, with a main pump that conveys a coolant through the primary circuit, a bypass line through which the coolant bypasses the battery, and a thermally insulated secondary circuit for the battery with which the temperature of the battery can be controlled independently of the electric motor.

The thermal management module obtained with the invention, which has the features of claim 1, has the advantage that there is supplementary cooling for a quick charging of the battery, thus reliably preventing or delaying faulty regulation of the charging performance due to overheating of the battery during the charging process, in particularly a quick charging process. The supplementary cooling effectively cools the battery, even in high ambient temperatures. Irreversible damage to, or overheating, the battery can thus be prevented. The thermal management module improves and shortens the charging process.

A thermal management module for an electric vehicle is proposed that can be placed in a cooling circuit or coolant circuit for an electric vehicle that regulates or controls the flow of a coolant through the circuit, characterized in that the thermal management module contains at least one regulator, which regulates or controls the coolant flow through at least one heat sink.

A thermal management module is understood to be a replaceable element in an overall system, apparatus, or machine, that forms a closed functional unit. The thermal management module is designed to receive the coolant and then discharge it. The thermal management module can contain one or more intake and outlet elements through which the coolant enters and exits the thermal management module. These intake/outlet elements can be tubes, hoses, and/or flanges. The module can contain one or more module elements. A module element is a mechanism that conveys coolant. The module element can also be a regulator with which the coolant flow can be controlled or regulated in the circuit.

A cooling circuit is understood to be a circuit for a coolant in a motor vehicle. For the present invention, this cooling circuit is for an electric vehicle and the components thereof. The cooling circuit contains at least one thermal management module obtained with the invention. The cooling circuit can also contain a fan, a coolant cooler, an indirect condenser, and at least one pump.

Coolant is a gas, liquid or solid, or a mixture thereof, that absorbs heat. This absorption is in the form of thermal energy that heats the coolant, or transformation enthalpy that changes the aggregate state of the coolant. The coolant can be water with or without additives. One such additive could be antifreeze.

A regulator is a component that controls or regulates the coolant flow. This regulation or control can be mechanical and/or electrical. The at least one regulator can be a valve and/or a pump. The at least one regulator can be designed to receive an electric signal. The valve is designed to receive the electric signal and fully or partially open or close on the basis thereof. The pump is designed to receive the electric signal and increase or reduce the pumping performance, or switch on or off, on the basis thereof.

A heat sink is a component that absorbs heat. For the invention, this heat sink is a component in an electric vehicle that is or can be thermally connected to the cooling circuit. In other words, the heat sink can be permanently connected to the cooling circuit, or it can be connected thereto as needed. This means that the at least one heat sink can be connected to the cooling circuit such that coolant can flow through it. The at least one regulator can be designed to activate this connection. The at least one heat sink can be a component in or near the cooling circuit. Ideally, the at least one heat sink is a component that remains passive during quick charging processes, which is capable of absorbing a lot of heat. The at least one heat sink can be a motor, transmission, and/or power electronics. Activating the at least one heat sink has the advantage of providing supplementary cooling by reversing some of the energy flow, i.e. diverting heat from the coolant to a component in the electric vehicle during a quick charging process. When operating the vehicle, this heat is then conducted to the coolant. In other words, a component that generates heat when driving the vehicle forms a heat sink during the charging process. In other words, the flow of energy, or heat transfer, is reversed. Activating the at least one heat sink has the advantage that due to the thermal inertia of the heat sink and the transfer of heat from the heat sink to the environment, the cooling performance is improved during the charging process.

The thermal management module can also contain a control unit. This is a device that sends an electric signal to the at least one regulator. The control unit can receive an electric signal from at least one sensor and send it to the at least one regulator. The sensor can be a thermal sensor. This sensor can be designed to measure the temperature of the at least one heat sink and/or the battery, and send an electric signal to the control unit. The control unit can be designed to send a corresponding signal to the at least one regulator. The at least one regulator can be designed to receive the signal from the sensor and activate one or more heat sinks, and/or control or regulate the flow and/or direction of the coolant to the at least one heat sink.

In one embodiment, the at least one heat sink is a predetermined component, or a component determined on the basis of at least one parameter. A predetermined component is a component in an electric vehicle that can act as a heat sink during a quick charging process. The at least one predetermined component can be permanently connected to the cooling circuit. In this case, the at least one predetermined component is also connected to the cooling circuit not during the charging process, e.g. when driving or when the vehicle is parked. A thermal management module that has at least one predetermined component has the advantage of a simple construction, and is less liable to malfunction. Furthermore, this at least one predetermined component can be a heat sink that can be activated as needed. In this case, the at least one predetermined component can be thermally connected to the cooling circuit during the charging process. The at least one regulator can be designed to activate the at least one predetermined component. This has the advantage that the at least one heat sink can be activated as needed. The at least one predetermined component can be an electric motor. The at least one heat sink can also be a component determined on the basis of at least one parameter. The at least one parameter can be the temperature of the battery for the electric vehicle, the temperature of one or more components in the motor vehicle, and/or the ambient temperature, i.e. the air temperature outside the motor vehicle. The at least one regulator can be designed to activate one or more heat sinks if a predetermined maximum temperature for the battery has been reached or exceeded, and/or the ambient temperature exceeds a predefined threshold value. The at least one regulator can also be designed to activate at least one component based on the temperature thereof. The at least one regulator is ideally designed to activate one or more components that are cooler than a predefined threshold temperature. In other words, until reaching a predetermined threshold temperature, a component acts as a heat sink. Once it exceeds this threshold temperature, it can no longer absorb heat from the coolant. The at least one regulator can then disconnect this component, e.g. by closing a valve and/or switching off a pump, and/or it can activate at least one other component. Activating components based on parameters enables cooling that is adapted to specific conditions. The thermal management module can contain one or more predetermined components that are permanently connected to the cooling circuit, and/or can be activated as needed. The thermal management module can also contain one or more components that are determined on the basis of at least one parameter.

In one embodiment, the at least one regulator is designed to reverse the coolant flow through at least one part of the cooling circuit. The at least one regulator is designed to reverse the flow of the coolant at the start of the charging process and maintain this reversed flow during the charging process. Reversing the flow is understood to mean that the coolant flows in the direction opposite the normal direction. The normal direction is understood to mean the direction a coolant normally flows in a cooling circuit from the prior art. A cooling circuit from the prior art is understood to be a cooling circuit designed primarily for cooling the components of the motor vehicle that are particularly sensitive to temperature, and subsequently cool those that are less sensitive to temperature. The cooling takes place through heat transfer to the coolant. In cooling circuits from the prior art, the components surrounding the electric motor, e.g. power electronics, are normally cooled prior to cooling the electric motor itself. This ensures that the components surrounding the electric motor, in particular the temperature-sensitive power electronics, are sufficiently cooled. Sufficient cooling of the power electronics means that the temperature of the power electronics is kept below 65° C., for example. The electric motor can tolerate higher temperatures than the power electronics. The temperature of the electric motor is kept below 100° C., for example. According to the invention, the normal flow direction is maintained while driving the motor vehicle in order to cool the electric motor and power electronics while driving. With the invention, the direction the coolant flow is reversed prior to or at the start of the charging process, and maintained throughout the charging process. The coolant can flow in the reversed direction through part of the cooling circuit or the entire cooling circuit. The demands on the cooling circuit during the charging process, in particular a quick charging process, differ from those when driving the vehicle. During a quick charging process, a great deal of heat is generated in a very short time. The cooling circuit from the prior art cannot discharge enough heat from batteries during a quick charging process, particularly in warm weather, thus diminishing the overall performance, and resulting in longer charging times. With the invention, at least one component in the motor vehicle is used as a heat sink, such that heat can be discharged from the coolant to the at least one heat sink. Reversing the flow at the start of the charging process, in particular a quick charging process, results in the more thermally robust components being first thermally connected to the coolant, and subsequently connecting the temperature-sensitive components thereto. The temperature-sensitive components through which the coolant first flows thus absorb a lot of heat. The subsequent components absorb less heat. On the whole, a great deal of heat can be transferred from the batteries to the coolant and the components functioning as heat sinks during the quick charging process. Reversing the flow protects the batteries and other temperature-sensitive components in the motor vehicle from overheating, preventing a decrease in performance during quick charging processes, and at high ambient temperatures, resulting in a short charging time.

In one embodiment, the at least one regulator is a valve. This valve is designed the control or regulate the flow of coolant in the cooling circuit. The valve can be a check valve, selector valve, flow-control valve, pressure valve, or directional valve, e.g. a 3/2 directional valve. The valve is preferably a cross-shaped valve. A cross-shaped valve is designed to reverse the flow of the coolant in the cooling circuit. This can be an electric valve. An electric valve is understood to be a valve that can be controlled electrically, such that the opening of the valve can be controlled or regulated by a control unit. A thermal management module with a valve has the advantage of a particularly compact and light structure.

In one embodiment, the at least one regulator is a pump with a check valve. The at least one regulator is preferably a centrifugal pump. A centrifugal pump has a rotating shaft that conveys coolant through kinetic forces.

In one embodiment, the at least one heat sink is an electric motor. This electric motor is the motor that powers the vehicle. The electric motor is passive during the charging process, does not generate heat, and does not need to be cooled. The electric motor can be used as a heat sink during the charging process, particularly a quick charging process. The electric motor has a large thermal mass, i.e. it can absorb a lot of heat. The electric motor can absorb more heat than the power electronics surrounding the electric motor. The electric motor is less sensitive to temperature than power electronics, and can absorb more heat without becoming damaged. The electric motor can also absorb a lot of heat because it is made of materials with higher thermal conductivity. By way of example, an electric motor that weighs 90 kg (Cu/Fe) can absorb 1,800 kilojoules when heated 50 Kelvin. The electric motor can provide 3,000 watts of cooling in 10 minutes. A heat sink formed by an electric motor has the advantage that a great deal of cooling can be obtained during the quick charging, which is particularly advantageous in hot weather.

In one embodiment, the thermal management module has at least one bypass, or bypass line. A bypass is a component designed to circumvent at least one element. This circumvention is understood to mean that the flow of the coolant is conducted, or redirected, such that the coolant does not come in contact with the element(s) in question. In other words, these elements are removed from the flow path of the coolant. The at least one element can be a component of the electric vehicle that is connected to or near the cooling circuit and/or coolant circuit. This can be a temperature-sensitive element such as a component in the power electronics, or the entire power electronics. The at least one bypass can be a line, tube, and/or hose. The at least one bypass can be switched on and off. When this bypass is shut off, the coolant flows through the component in question, and when it is switched on, the coolant circumvents the element. The at least one bypass can contain a valve and/or a pump. These switch the bypass on and off, and/or regulate or control the flow of coolant through the bypass. A thermal management module with at least one bypass has the advantage that temperature-sensitive components are protected against overheating during quick charging processes.

The invention also relates to a cooling circuit for an electric vehicle that contains at least one thermal management module obtained with the invention. A cooling circuit is understood to be a circuit for a coolant in a motor vehicle. The circuit contains tubes, lines, and/or hoses designed to accommodate a coolant flow. The cooling circuit contains at least one pump designed to convey the coolant. The cooling circuit contains one or more valves and/or pumps designed to regulate or control the coolant flow. The cooling circuit contains a fan, a coolant cooler, and an indirect condenser. The cooling circuit can be thermally connected to a refrigerant circuit. With a cooling circuit thermally connected to a refrigerant, heat is exchanged between the cooling circuit and a refrigerant circuit. This can take place through direct contact. The refrigerant circuit contains an indirect condenser, a chiller, and at least one pump, and is designed to cool the batteries in an electric vehicle.

The invention also relates to a method for cooling a battery for quick charging an electric vehicle. The method comprises the following steps:
b) detecting the starting point of a quick charging process,
d) activating a coolant flow through at least one heat sink,
e) detecting the end point of the quick charging process, and
g) deactivating the coolant flow through the at least one heat sink.

The starting point of a quick charging process is detected in step b). A quick charging process is understood to be a charging of the batteries in an electric vehicle that lasts less than 3 hours, preferably less than 60 minutes, particularly preferably less than 30 minutes. Detecting the starting point of a quick charging process is understood to mean detecting when an electric current begins to flow from an external apparatus, preferably a quick charging apparatus, to the batteries, in which the electric current is detected, and the starting point is identified. The electric current can be detected by at least one sensor. The starting point can be detected by a control unit. The control unit identifies the starting point and issues an electric signal. The electric signal can be sent to at least one apparatus, at least one element, and/or at least one component, preferably at least one regulator.

A coolant flow is activated through at least one heat sink in step d). Activating this flow through at least one heat sink is understood to mean that a connection is obtained between the cooling circuit and the at least one heat sink, which allows coolant to flow through the at least one heat sink. This activation can be obtained with at least one regulator that activates the at least one heat sink. The at least one regulator can be a valve and/or pump. The at least one regulator can receive an electric signal with which it activates and/or regulates or controls the flow of coolant through the at least one heat sink. The at least one regulator preferably receives the electric signal from the control unit. The at least one regulator receives the electric signal from the control unit that is issued after detecting the starting point of the quick charging process, and switches the at least one heat sink on.

The end point of the quick charging process is detected in step e). This detection of the end point of the quick charging process is understood to mean that an interruption or completion of the receiving of current from the external apparatus, preferably the quick charging apparatus, by the batteries in the electric vehicle has been detected. The end point can also be detected by detecting a predetermined charging state of the batteries, e.g. 100% charged. The electric current and/or the predetermined charging state can be detected by the at least one sensor. The end point can be detected by the control unit. The control unit is designed to detect the end point and issue an electric signal. The electric signal can be sent to an apparatus, element and/or component, preferably the at least one regulator.

The flow of coolant through the at least one heat sink is shut off in step g). This is understood to mean that the connection between the cooling circuit and the at least one heat sink is terminated or interrupted, such that coolant no longer flows through the at least one heat sink. It can be switched off by the at least one regulator that activates the at least one heat sink. The at least one regulator preferably receives the electric signal from the control unit. The at least one regulator receives the electric signal from the control unit that is issued after detecting the end of the quick charging process, and shuts off the at least one heat sink. The flow of coolant through the at least one heat sink can be shut off by closing the at least one valve and/or shutting off the at least one pump.

In one embodiment, the method obtained with the invention comprises the following steps:
b) detecting the starting point of a quick charging process,
c) a first reversal of the flow direction of the coolant,
d) activating a coolant flow through at least one heat sink,
e) detecting the end point of the quick charging process,
f) a second reversal of the flow direction of the coolant, and
g) deactivating the coolant flow through the at least one heat sink.

A starting point of a quick charging process is detected in step b). Step c) follows step b).

A first reversal of the coolant flow takes place in step c). This means that the flow of the coolant is reversed from the normal direction the coolant flows through the cooling circuit. The normal direction is understood to be the direction the coolant flows through the cooling circuit when driving. The first reversal can be obtained with at least one regulator. The at least one regulator reverses the flow of coolant and maintains this direction during the charging process. This reversal is preferably obtained with a cross-shaped valve and/or centrifugal pump. The at least one regulator can be designed to receive an electric signal from a control unit and reverse the flow based thereon.

A coolant flow is activated through at least one heat sink in step d). Step d) can take place prior to, after, or at the same time as step c).

The end of the quick charging process is detected in step e).

The coolant flow is reversed a second time in step f). A second reversal is understood to mean that the coolant then resumes flowing in the normal direction through the cooling circuit. The first reversal can be obtained with the at least one regulator.

The flow of coolant through the at least one heat sink is shut off in step g). Steps f) and g) take place after step e). Step g) can take place prior to, after, or at the same time as step f).

In one embodiment, the method obtained with the invention comprises the following steps:
a) detecting at least one starting state parameter that characterizes a starting state and outputting information characterizing the starting state.
b) detecting the starting point of a quick charging process,
c) a first reversal of the flow direction of the coolant,
d) activating a coolant flow through at least one heat sink,
e) detecting the end point of the quick charging process,
f) a second reversal of the flow direction of the coolant, and
g) deactivating the coolant flow through the at least one heat sink.

At least one starting state parameter that characterizes a starting state is detected and information characterizing the starting state is output in step a). Step a) preferably takes place before steps b) to g). The at least one starting state parameter can be detected by a sensor. The sensor outputs information that characterizes the starting state. The sensor can output this information in the form of an electric signal. The information, or electric signal, can be sent to a display and/or control unit that outputs an electric signal to a display. A display is understood to be a device that can output information to the driver of the motor vehicle that characterizes the starting state. The information can be output acoustically and/or visually. The display can be a screen and/or microphone.

In one embodiment, the at least one starting state parameter that characterizes a starting state is a charging state of a battery, an ambient temperature, the temperature of the at least one heat sink, and/or the distance to at least one quick charging station. The charging state is expressed in percentages. The ambient temperature is the temperature of the air outside the vehicle. The temperature of the at least one heat sink is the temperature of at least one component that serves as a heat sink during the quick charging process. The at least one heat sink can be a predetermined component or a component determined on the basis of at least one parameter. The distance to at least one quick charging station is the distance to the closest quick charging station. Outputting information characterizing the starting state allows the driver of the vehicle to determine the optimal point in time for a quick charging process. A low temperature of the at least one heat sink, a low charging state, a low ambient temperature, and a short distance to a quick charging station indicate optimal charging points.

Other advantages and features of the invention can be derived from the following descriptions of preferred embodiments of the subject matter of the invention in reference to the drawings.

Therein, schematically:

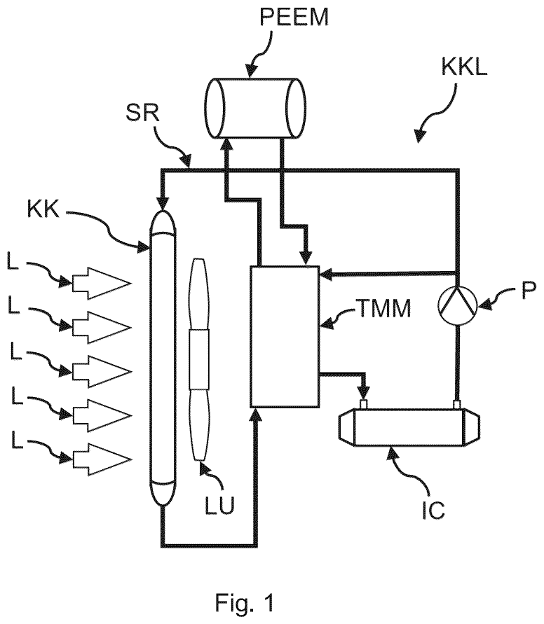

FIG. 1 shows a first block diagram of a thermal management module in a cooling circuit,

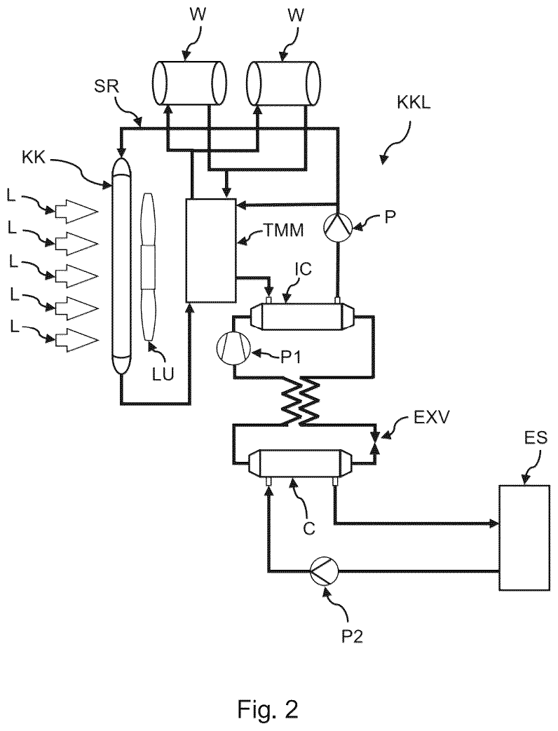

FIG. 2 shows a second block diagram of a cooling circuit and a refrigerant circuit obtained with the invention,

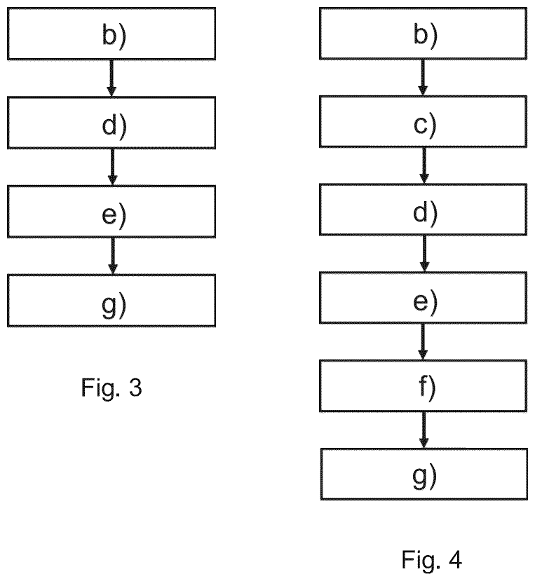

FIG. 3 shows a first flow chart of a method obtained with the invention for cooling a battery for a quick charging of an electric automobile,

FIG. 4 shows a second flow chart of a method obtained with the invention for cooling a batter for a quick charging of an electric automobile, and

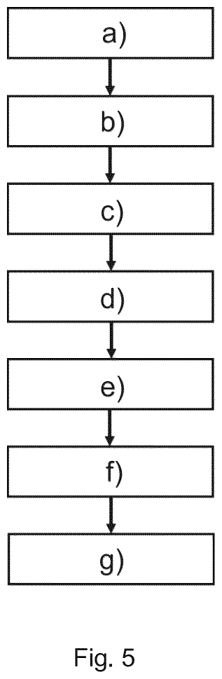

FIG. 5 shows a third flow chart of a method obtained with the invention for cooling a batter for a quick charging of an electric automobile.

FIG. 1 shows a first block diagram of a thermal management module TMM obtained with the invention in a cooling circuit KKL. The cooling circuit KKL contains a coolant cooler KK designed to cool the coolant KM. The cooling circuit KKL contains a fan LU designed to move air L and cool the coolant cooler KK. The thermal management module TMM is designed to receive the coolant KM and discharge it. The thermal management module TMM contains intake and outlet elements designed to supply the coolant KM to the thermal management module TMM and remove it therefrom. The Thermal management module TMM contains a regulator R (not shown) that is designed to control or regulate the flow of coolant KM through the electric motor PEEM, which functions as a heat sink W. The electric motor PEEM serves as a heat sink W. The coolant KM flows in the direction SR through the cooling circuit KKL. The flow direction SR for the coolant KM in the cooling circuit KKL is indicated by the arrow. A pump P is designed to propel the coolant KM. The coolant KM flows from the thermal management module TMM to the electric motor PEEM, back into the thermal management module TMM, into the indirect condenser IC, through the pump P, into the coolant cooler KKL, and back into the thermal management module TMM.

FIG. 2 shows a second block diagram of a cooling circuit KKL obtained with the invention, and a refrigerant circuit. The cooling circuit KKL contains a thermal management module TMM obtained with the invention. The cooling circuit KKL also contains a fan LU that causes an air flow, a coolant cooler KK, an indirect condenser IC, a pump P and two heat sinks W. The thermal management module TMM obtained with the invention contains a regulator R (not shown) that is designed to regulate or control the flow of coolant KM through the two heat sinks W. The regulator R is designed to activate one or both heat sinks W, as needed during a quick charging process. The coolant KM flows in the direction SR through the cooling circuit KKL. The flow direction SR is indicated by the arrow. The cooling circuit KKL obtained with the invention is in thermal contact with a refrigerant circuit, such that heat can be exchanged between the cooling circuit KKL and the refrigerant circuit. The refrigerant circuit contains an indirect condenser IC, a first pump P1, a chiller C, an electronic expansion valve EXV and a second pump P2. The refrigerant circuit is designed to cool the batteries ES in an electric automobile.

FIG. 3 shows a first flow chart for a method obtained with the invention for cooling a battery ES for a quick charging of an electric automobile. The method comprises the step b) detecting a starting point SZP of a quick charging process, d) activating a flow of coolant KM through an electric motor PEEM, e) detecting an end point EZP of the quick charging process, and g) shutting off the flow of coolant KM through the electric motor PEEM. A sensor detects the starting point SZP in step b), in that the sensor detects a current flowing from a quick charging apparatus to the battery ES in the electric automobile. The sensor outputs and electric signal to a control unit. The control unit receives the electric signal from the sensor and detects the starting point SZP. The control unit outputs an electric signal to a valve V in a thermal management module obtained with the invention in step d). The valve V opens and the refrigerant K flows through an electric motor PEEM functioning as a heat sink W. The sensor detects that the battery in the electric automobile is fully charged, i.e. has a charging state of 100%, in step e). Another sensor detects that current no longer flows from the quick charging station to the battery. Each of the sensors issues an electric signal. These signals are sent to the control unit. The control unit receives the signals and detects the end point EZP. The control unit outputs an electric signal to the valve V in step g). The valve V receives the signal and closes. The flow of coolant KM through the electric motor PEEM functioning as a heat sink W is interrupted or terminated.

FIG. 4 shows a second flow chart for a method obtained with the invention. The method comprises step b) detecting the starting point SZP of a quick charging process, c) a first reversal EU of the flow direction SR of coolant KM, d) activating a coolant KM flow through the electric motor PEEM, e) detecting the end point EZP of the quick charging process, f) a second reversal ZU of the flow direction SR of coolant KM, and g) deactivating the coolant KM flow through the electric motor PEEM. The control unit detects the starting point SZP in step b). The control unit outputs an electric control signal to a centrifugal pump P in step c). The centrifugal pump P receives the electric control signal and reverses direction, thus reversing the flow direction SR of the coolant KM. The coolant KM flows in the reverse direction SR through the cooling circuit KKL.

The control unit outputs another electric control signal to the valve V in a thermal management module TTM obtained with the invention in step d). The valve V receives the other electric control signal and opens. Opening the valve V causes the coolant KM to flow through the electric motor PEEM. The electric motor PEEM functions as a heat sink W, i.e. the electric motor PEEM absorbs heat from the coolant KM, thus cooling the coolant KM.

The control unit detects the end point EZP of the quick charging process in step e). In step f), the control unit outputs a third electric control signal to the centrifugal pump P. The centrifugal pump P receives the third electric control signal and reverses the flow direction. The coolant KM flows in the original direction SR, i.e. in the direction SR prior to the starting point SZP of the quick charging process, through the cooling circuit KKL.

The control unit outputs a fourth electric control signal to the valve V in step g). The valve V closes and prevents the coolant K from flowing through the electric motor PEEM. The electric motor PEEM is disconnected from the cooling circuit KKL. The electric motor PEEM no longer functions as a heat sink W.

FIG. 5 shows a third flow chart for a method obtained with the invention. The method comprises step a) detecting at least one starting point parameter (AP) that characterizes a starting state and outputting information characterizing the starting state, b) detecting a starting point SZP of a quick charging process, c) a first reversal EU of the flow direction SR of a coolant KM, d) activating flow of the coolant KM through an electric motor PEEM, e) detecting an end point EZP of the quick charging process, f) a second reversal ZU of the flow direction SR for the coolant KM, and g) shutting off the flow of coolant KM through the electric motor PEEM.

Numerous sensors detect numerous starting state parameters AP in step a). The starting state parameters AP are the charging state of the batteries in the electric automobile, the distance to the nearest quick charging station, the ambient temperature and the temperature of the electric motor PEEM. The sensors each output an electric signal to a control unit. The control unit outputs an electric control signal to a screen. The screen is inside the passenger compartment of the electric automobile. The screen outputs information to the driver of the electric automobile that characterizes the starting state, i.e. the screen informs the driver as to whether the current conditions are appropriate for quick charging.

The specification can be readily understood with reference to the following Numbered Paragraphs:

Numbered Paragraph 1. A thermal management module (TMM) for an electric vehicle, wherein the thermal management module (TMM) can be placed in a cooling circuit (KKL) in an electric vehicle, and wherein the thermal management module (TMM) is designed to regulate or control the flow of a coolant (KM) in the cooling circuit (KKL), characterized in that the thermal management module (TMM) contains at least one regulator (R), wherein the at least one regulator (R) is designed to regulate or control the flow of the coolant (KM) through at least one heat sink (W).

Numbered Paragraph 2. The thermal management module (TMM) according to Numbered Paragraph 1, characterized in that the at least one heat sink (W) is a predetermined component (K) or a component (K) determined on the basis of at least one parameter (PA).

Numbered Paragraph 3. The thermal management module (TMM) according to either of the preceding Numbered Paragraphs, characterized in that the at least one regulator (R) is designed to reverse the flow direction (SR) of the coolant (KM) through at least one part of the cooling circuit (KKL).

Numbered Paragraph 4. The thermal management module (TMM) according to any of the preceding Numbered Paragraphs, characterized in that the at least one regulator (R) is a valve (V), preferably a cross-shaped valve (V).

Numbered Paragraph 5. The thermal management module (TMM) according to any of the preceding Numbered Paragraphs, characterized in that the at least one regulator (R) is a pump (P) with a check valve, preferably a centrifugal pump (P).

Numbered Paragraph 6. The thermal management module (TMM) according to any of the preceding Numbered Paragraphs, characterized in that the at least one heat sink (W) is an electric motor (PEEM).

Numbered Paragraph 7. The thermal management module (TMM) according to any of the preceding Numbered Paragraphs, containing at least one bypass (B), wherein the at least one bypass (B) is designed to circumvent at least one predetermined element (E).

Numbered Paragraph 8. A cooling circuit (KKL) for an electric vehicle, containing at least one thermal management module (TMM) according to any of the preceding Numbered Paragraphs.

Numbered Paragraph 9. A method for cooling a battery (ES) for a quick charging process of an electric vehicle, comprising the following steps:
b) detecting the starting point (SZP) of a quick charging process,
d) activating a coolant (KM) flow through at least one heat sink (W),
e) detecting the end point (EZP) of the quick charging process, and
g) deactivating the coolant (KM) flow through the at least one heat sink (W).

Numbered Paragraph 10. The method for cooling a battery (ES) according to Numbered Paragraph 9, comprising the following steps:
c) a first reversal (EU) of the flow direction (SR) of the coolant (KM), and
f) a second reversal (ZU) of the flow direction (SR) of the coolant (KM), wherein the first reversal (EU) of the flow direction (SR) of the coolant (KM) takes place after a) detecting the starting point (SZP) of the quick charging process and the second reversal (ZU) of the flow direction (SR) of the coolant (KM) takes place after e) detecting the end point (EZP) of the quick charging process.

Numbered Paragraph 11. The method for cooling a battery (ES) according to Numbered Paragraph 9 or 10, comprising the following step:
a) detecting at least one starting state parameter (AP) that characterizes a starting state and outputting information characterizing the starting state.

Numbered Paragraph 12. The method according to Numbered Paragraph 11, characterized in that the at least one starting state parameter (PA), which characterizes a starting state, is a charging state of the battery, an ambient temperature, a temperature of the at least one heat sink (W), and/or a distance to at least one quick charging station.

### LIST OF REFERENCE SYMBOLS

AP starting state parameter
B bypass
C chiller
ES battery
EU first flow reversal
EXV electronic expansion valve
EZP end point
IC indirect condenser
K component
KK coolant cooler
KKL cooling circuit
KM coolant
L air or air flow
LU fan
P pump
P1 first pump in refrigerant circuit
P2 second pump in refrigerant circuit
PA parameter
PEEM electric motor (Power Electronic Electric Motor)
R regulator
SR coolant flow direction
TMM thermal management module
V valve
W heat sink
ZU second flow reversal

1-12. (canceled)

13. A thermal management module for an electric vehicle, wherein the thermal management module is configured to be placed in a cooling circuit in an electric vehicle, and wherein the thermal management module is configured to regulate or control the flow of a coolant in the cooling circuit, wherein the thermal management module comprises at least one regulator, wherein the at least one regulator is configured to regulate or control the flow of the coolant through at least one heat sink.

14. The thermal management module according to claim 13, wherein the at least one heat sink is a predetermined component or a component determined on the basis of at least one parameter.

15. The thermal management module according to claim 13, wherein the at least one regulator is configured to reverse a flow direction of the coolant through at least one part of the cooling circuit.

16. The thermal management module according to claim 13, wherein the at least one regulator is a valve.

17. The thermal management module according to claim 13, wherein the at least one regulator is a pump with a check valve.

18. The thermal management module according to claim 13, wherein the at least one heat sink is an electric motor.

19. The thermal management module according to claim 13, further comprising at least one bypass, wherein the at least one bypass is configured to circumvent at least one predetermined element.

20. A cooling circuit for an electric vehicle, comprising at least one thermal management module according to claim 13.

21. A method for cooling a battery for a quick charging process of an electric vehicle, comprising the following steps:
b) detecting a starting point of a quick charging process,
d) activating a coolant flow through at least one heat sink,
e) detecting an end point of the quick charging process, and
g) deactivating the coolant flow through the at least one heat sink.

22. The method for cooling a battery according to claim 21, further comprising the following steps:
c) a first reversal of a flow direction of the coolant, and
f) a second reversal of the flow direction of the coolant,
wherein the first reversal of the flow direction of the coolant takes place after step (a) detecting the starting point of the quick charging process and after the second reversal of the flow direction of the coolant takes place after step (e).

23. The method for cooling a battery according to claim 21, further comprising the following step:
a) detecting at least one starting state parameter that characterizes a starting state and outputting information characterizing the starting state.

24. The method according to claim 23, wherein the at least one starting state parameter, which characterizes a starting state, is a charging state of the battery, an ambient temperature, a temperature of the at least one heat sink, and/or a distance to at least one quick charging station.

25. The thermal management module according to claim 16, wherein the at least one regulator is a cross-shaped valve.

26. The thermal management module according to claim 17, wherein the pump is a centrifugal pump.
